(19) United States
(12) Patent Application Publication
(10) Pub. No.: US 2025/0363753 A1
(43) Pub. Date: Nov. 27, 2025

(54) METHOD FOR ANCHORING A VIRTUAL OBJECT, ASSOCIATED SYSTEM

(71) Applicant: ARY, LES LOGES-EN-JOSAS (FR)

(72) Inventor: Eric HEURTIER, LES LOGES-EN-JOSAS (FR)

(21) Appl. No.: 18/867,590

(22) PCT Filed: May 23, 2023
(86) PCT No.: PCT/EP2023/063803

§ 371 Date: Nov. 20, 2024

(30) Foreign Application Priority Data
May 23, 2022 (FR) 2204928

(51) Int. Cl. G06T 19/00; G01S 5/14; G06F 3/0346; G06T 15/10; H04W 4/80

(52) U.S. Cl. CPC G06T 19/006; G01S 5/14; G06F 3/0346; G06T 15/10; H04W 4/80

(57) ABSTRACT

A method for anchoring a virtual object to be displayed on an electronic display of an electronic terminal at a given position of space, the method including selection of a virtual object and identification of the virtual object by the positioning beacon; measurement of an orientation of the electronic terminal with respect to a reference from a second compass system; generation of a command to send a first signal; measurement of a transmission parameter of the first signal by the positioning beacon; calculation of a first position from the second orientation and the transmission parameter of the electronic terminal; anchoring of a position of the virtual object at the first position, the anchoring including an association of the virtual object with the first position.

### FIELD OF THE INVENTION

The invention relates to methods implemented by computers and/or by systems comprising electronic equipment to exploit data of a virtual environment in a real environment. The field of the invention more particularly aims at methods for anchoring a data in the real world to give access to this data to a third party.

### PRIOR ART

Solutions exist making it possible to anchor data at a given position in a real environment. In this case, it is necessary to vectorize all or part of the real environment. The data is positioned in a repository linked to the vectorized environment. It is understood that the data may be virtual objects, media or even text.

One interest is to make it possible to share data located in a real environment with other individuals. However, this solution has the drawback of having to be accessible to all the parties wishing to exchange information. This configuration is practical when one has access, generally operated by an application, to the real environment, but this is not always the case, in addition it is very difficult to duplicate the vectorization of a real environment.

This solution makes it possible to see data in a real context, such as their living room or office, but only through a terminal or system having carried out the vectorization. However, this solution is restrictive on several counts. Indeed, if it is wished to see a layout of a piece of furniture represented within a context that changes over time, it is necessary to carry out a new 30 vectorization of the place. Another drawback is that it is necessary for each person wishing to access a shared anchored object to have access to the vectorized place or to vectorize the place themselves. This means notably that a large amount of data transits from one item of equipment to another.

Furthermore, solutions exist making it possible to locate virtual objects in the real environment. This is notably the case for a game like Pokemon Go, which is a registered trademark. The game consists in retrieving virtual objects disposed at positions in the real environment. However, a limitation of this technology is GPS location, which does not allow objects to be precisely located inside a room, the signal often being too attenuated and not allowing sufficient accuracy to be obtained.

There is a need to locate data in a real environment that is located in enclosed places such as homes, factories, offices, stores, museums or any other place that can be used to exchange localized data between individuals.

### SUMMARY OF THE INVENTION

According to a first aspect, the invention relates to a method for anchoring a virtual object to be displayed on an electronic display of an electronic terminal at a given position of space, said method including:
Initialization of a wireless communication between an electronic terminal and at least one positioning beacon to record an identifier of said electronic terminal in a memory of said positioning beacon;
Selection of a virtual object from the electronic terminal and identification of said virtual object by said positioning beacon;
Measurement of a first orientation of the positioning beacon with respect to a reference from a first orientation device;
Measurement of a second orientation of the electronic terminal with respect to a reference from a second orientation device;
Generation of a command to send a first signal generated by an UWB communication interface of the electronic terminal;
Acquisition by the positioning beacon of a first signal sent by means of an UWB communication interface of the electronic terminal;
Measurement of a transmission parameter of the first signal by the positioning beacon;
Transmission of a second data encoding the second orientation by the electronic terminal;
Acquisition by the positioning beacon of the second orientation sent by the electronic terminal;
Calculation of a first position from the second orientation and the transmission parameter of said electronic terminal;
Recording of the first position defined in relation to the beacon;
Anchoring of a position of the virtual object at the first position, said anchoring including an association of said virtual object with the first position.

According to a first aspect, the invention relates to a method for anchoring a virtual object to be displayed on an electronic display of an electronic terminal at a given position in space, said method being implemented by a single beacon and said electronic terminal, said method comprising:
Initialization of a wireless communication between an electronic terminal and a positioning beacon to record an identifier of said electronic terminal in a memory of said positioning beacon;
Selection of a virtual object from the electronic terminal and identification of said virtual object by said positioning beacon;
Measurement of a first orientation of the positioning beacon with respect to a reference from a first orientation device;
Measuring a second orientation of the electronic terminal with respect to a reference from a second orientation device;
Generation of a command to send a first signal generated by an UWB communication interface of the electronic terminal;
Acquisition by the positioning beacon of a first signal sent by means of an UWB communication interface of the electronic terminal;
Measurement of a transmission parameter of the first signal by the positioning beacon;
Transmission of a second data encoding the second orientation by the electronic terminal;
Acquisition by the positioning beacon of the second orientation sent by the electronic terminal;
Calculation of a first position from the second orientation and the transmission parameter of said electronic terminal;
Recording of the first position defined in relation to the beacon;
Anchoring of a position of the virtual object at the first position, said anchoring including an association of said virtual object with the first position.

One advantage of using only one beacon is to reduce the number of items of equipment required to locate the terminal and display the virtual object on the display of the electronic terminal. The display is then able, thanks to an augmented reality component, to display the virtual object on the image acquired by the optics of the terminal as a function of the position and the orientation of said electronic terminal on the one hand and the position of said virtual object in space on the other hand.

According to a second aspect, the invention relates to a method for anchoring a virtual object to be displayed on an electronic display of an electronic terminal at a given position of space, said method including:
Initialization of a wireless communication between an electronic terminal and a plurality of positioning beacons to record an identifier of said electronic terminal in a memory of said positioning beacon;
Selection of a virtual object from the electronic terminal and identification of said virtual object by said positioning beacon;
Generation of a command to send a first signal generated by an UWB communication interface of the electronic terminal;
Acquisition by the positioning beacons of a first signal sent by means of an UWB communication interface of the electronic terminal;
Measurement of a transmission parameter of the first signal by the positioning beacons;
Calculation of a first position from the transmission parameter of said electronic terminal and by means of a trilateration algorithm;
Recording of the first position defined with respect to a reference beacon chosen from all the beacons;
Anchoring of a position of the virtual object at the first position, said anchoring including an association of said virtual object with the first position.

According to one embodiment, the second data encoding the second orientation by the electronic terminal is transmitted:
By means of the sending of a second signal sent by a Bluetooth communication interface or;
By means of an encoding of the second data within the first signal sent by the UWB interface or;
By means of the sending of a third signal sent by a WIFI communication interface.

One advantage is to enable a position to be calculated with a more precise accuracy of the anchor to be generated that will be associated with the virtual object.

According to one embodiment, the measurement of the orientation of the electronic terminal and/or the positioning beacon carried out by the orientation device is performed by means of a compass system, a compass, a gyrometer or an inertial unit.

One advantage is to use the same magnetic reference, north in the case of a compass or compass system for example. In general, the orientation measurements of the terminal and the beacon are carried out with respect to a same magnetic reference.

One advantage is to have a component directly present in the terminal allowing a measurement to be calculated autonomously.

According to one embodiment, the first virtual object is selected from:
A memory of the electronic terminal;
A memory of the positioning beacon accessible from the electronic terminal by activation of a data exchange implemented by a WIFI or Bluetooth link;
A remote server memory accessible from the electronic terminal by activating a data exchange implemented by a WIFI or Bluetooth link.

One advantage is to allow a user to have libraries of virtual objects that may come from different data sources. One interest is to allow users to be granted access according to their rights, their interests or specific domains.

According to one embodiment, the first UWB signal sent by the electronic terminal is a message of a two way UWB data exchange sequence, so-called “Two way UWB ranging”, wherein a time of flight measurement makes it possible to calculate the distance between the electronic terminal and the positioning beacon.

One advantage is to exploit the resources of an already existing terminal, such as those of a smartphone.

According to one embodiment, the first UWB signal sent by the electronic terminal is a message of a one way UWB data transmission sequence wherein a measurement of the arrival time of the first signal makes it possible to calculate the distance between the electronic terminal and the positioning beacon, the calculation of the first distance being calculated from a prior synchronization of the clocks of the first electronic terminal and the positioning beacon.

One advantage of this solution is to avoid installing an UWB transmitter on one of the items of equipment such as the positioning beacon.

According to one embodiment, the first UWB signal sent by the electronic terminal is a message of an UWB data transmission sequence wherein a plurality of positioning beacons allows a measurement of the distance from the differences in arrival time of the first signal between pairs of positioning beacons making it possible to calculate the distance of the electronic terminal with respect to the positioning beacon.

One advantage is to make it possible to obtain a more accurate position of the terminal that does not necessarily require the exploitation of the orientation data. Indeed, with a plurality of positioning beacons, the position of the terminal may be obtained without exploiting its orientation with respect to magnetic north. Furthermore, the approximation made of the height may be improved by calculation of a position in space by trilateration or based on the notion of angle arrival.

According to one embodiment, the initialization step comprises a calibration of the first and second orientation devices, the calibration comprising a measurement of an orientation indication of the positioning beacon and a measurement of an orientation indication of the electronic terminal, said measurements being performed at a same reference position of each equipment.

One advantage is to be free of errors of calibration of the components of each apparatus by taking into account the relative deviations of said components.

According to one embodiment, the initialization step comprises an initialization of the positioning beacon, said initialization sequence comprising:
reception by the positioning beacon of a reference orientation of the electronic terminal for a given position of the electronic terminal;
reception by the positioning beacon of a reference height or arrival angle;
reception by the beacon of a user identifier and/or an identifier of the electronic terminal.

According to one embodiment, the virtual object is defined by a plurality of points and surfaces delimiting a region associated with a Cartesian reference frame and including a 3D representation that can be generated on a display of an electronic terminal according to a viewing angle.

According to one embodiment, the step of calculation of the first position comprises a step of assignment of at least one first reference coordinate corresponding to the height of the virtual object defined from a predefined configuration at a coordinate of the first position.

According to one embodiment, the step of calculation of the first position comprises:
An acquisition of an image of an area in space in which the virtual object is represented in 3D and is positioned at the first position on a display of the first electronic terminal;
A calculation of a second reference coordinate of at least one reference point associated with an automatically detected element from an algorithm for processing the acquired image in which the virtual object is represented;
Assignment of the second reference coordinate to a coordinate of the first position.

According to another aspect, the invention relates to a method for displaying a virtual object having been anchored according to the method of the invention comprising:
Sending an identification request from a second electronic terminal to the positioning beacon, said identification request including an identifier recorded in a memory of the second electronic terminal;
Generation of a reply including a virtual object identifier and said anchoring position of said virtual object with respect to the positioning beacon;
Display of said virtual object on a display of the second electronic terminal overlaying an image acquired by an optic of said second electronic terminal.

According to one aspect, the invention relates to a computer program product including at least a calculator and a memory and comprising instructions which, when the program is executed by a computer, lead the latter to implement the steps carried out by the electronic terminal of the method according to the invention.

According to one aspect, the invention relates to a computer program product including at least one calculator and a memory comprising instructions which, when the program is executed by a computer, lead the latter to implement the steps carried out by the positioning beacon of the method of the invention.

According to another aspect, the invention relates to a system for anchoring a virtual object, said system including:
A positioning beacon including a memory and a calculator and a first UWB communication interface;
An electronic terminal including a second UWB communication interface;
the positioning beacon and the electronic terminal being configured to implement the method of the invention.

According to one embodiment, the method for anchoring a virtual object to be displayed on an electronic display of an electronic terminal at a given position of space, said method including:
Initialization of wireless communication between an electronic terminal and at least one positioning beacon for:
   defining orientations of respective orientation devices of each item of equipment for a reference position of each item of equipment and;
   recording an identifier of said electronic terminal in a memory of said positioning beacon;
Selection of a virtual object from the electronic terminal and identification of said virtual object by said positioning beacon;
Measurement of a first orientation of the positioning beacon with respect to a reference from a first orientation device;
Measurement of a second orientation of the electronic terminal with respect to a reference from a second orientation device;
Generation of a command to send a first signal generated by an UWB communication interface of the electronic terminal;
Acquisition by the positioning beacon of a first signal sent by means of an UWB communication interface of the electronic terminal;
Measurement of a parameter for transmitting the first signal by the positioning beacon or by the electronic terminal;
Transmission of a second data encoding the second orientation by the electronic terminal or by the positioning beacon;
Acquisition by the positioning beacon of the second orientation sent by the electronic terminal or acquisition by the electronic terminal of the first orientation by the positioning beacon;
Calculation of a first position from the second orientation and the transmission parameter of said electronic terminal or calculation of a second position from the first orientation and the transmission parameter of said positioning beacon;
Recording of the first position defined with respect to the beacon or the second position defined with respect to the electronic terminal;
Anchoring of a position of the virtual object at the first position, said anchoring including an association of said virtual object with the first position.

### BRIEF DESCRIPTION OF THE FIGURES

Other features and advantages of the invention will become clearer upon reading the following detailed description, in reference to the appended figures, that illustrate:

FIG. 1: an example of a system according to the invention comprising a positioning beacon B₁ and a terminal T₁;

FIG. 2: an exemplary embodiment of an implementation of the anchoring method of the invention;

FIG. 3: an exemplary sequence of a UWB two way data exchange between the positioning beacon and the electronic terminal of the invention;

FIG. 4: an exemplary measurement and calculation from geometric considerations of the parameters of the position of the electronic terminal T₁;

FIG. 5: a representation of an interior of a room in which a user performs a pairing of his electronic terminal with a positioning beacon;

FIG. 6: a representation of an interior of a room in which a user anchors a virtual object corresponding in this example to a poster or a notice parallel to the plane of a wall of the room;

FIG. 7: a representation of an interior of a room in which another user views the virtual object previously anchored by means of the display of his electronic terminal, the display taking place in augmented reality,

FIG. 8: a representation of an interior of a room in which a user views the virtual object anchored by means of the display of his electronic terminal, the positioning of the virtual object being anchored by means of a multi-positioning beacon system.

### DESCRIPTION OF THE INVENTION

In the remainder of the description, a virtual object is designated as an object having a digital representation in a representation of a real environment. Typically, this virtual object may be viewed in augmented reality in an overlay of an image of a real environment such as a room or an office. The method of the invention finds a particularly interesting utility in an indoor environment, i.e. closed and in which a GPS-type satellite positioning is difficult to operate.

A virtual object may be considered as a digital object that can be viewed and/or edited by means of a computer preferably having a two-dimensional or three-dimensional geometric representation. However, an object of label type that can be activated to trigger the reading of a medium is also considered as a virtual object within the scope of the invention. The designation virtual is only intended to adapt the semantics of the object referred to and represented as an overlay of objects present in a real scene such as a sofa, a wall, a table, etc.

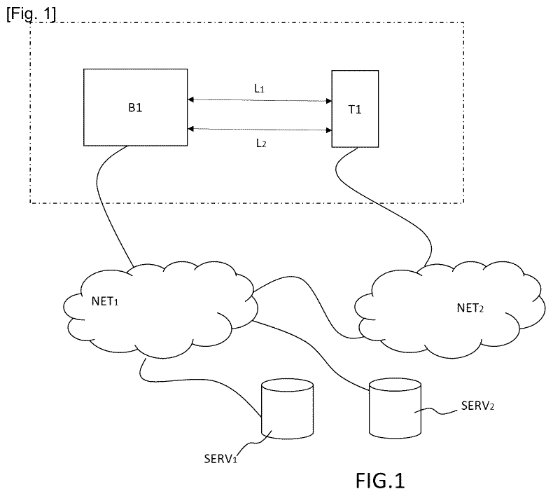

FIG. 1 shows a system according to the invention comprising a positioning beacon B₁ and a terminal T₁. The electronic terminal T₁ is, for example, a smartphone, an electronic tablet or a connected object such as a smartwatch or smart glasses or a connected headset. The electronic terminal T₁ includes at least a calculator, a memory, an optics and a display and a wireless communication interface. The display makes it possible to display an image of a selected virtual object OBVᵢ overlaying the image acquired by the optics of the electronic terminal T₁.

The positioning beacon B₁ is a powered unit disposed in a place such as an enclosed room, a hangar, or any other place likely to be of interest for the application of the invention. This beacon may also be called “tag” insofar as it transmits an UWB signal to determine a distance between said beacon/tag and the terminal receiving said UWB message, for example by measuring a time of flight of said message.

These latter two items of equipment B₁, T₁ are capable of establishing wireless data links L₁, L₂ shown in FIG. 1. The wireless link L₁ is activated according to a wireless data exchange protocol such as Bluetooth, Wifi, UWB or Lora. Any other wireless data transfer protocol may be implemented.

When the link L₁ is a Bluetooth low energy type link, the acronym of which is BLE, the electronic terminal T₁ may automatically start a so-called “Advertising Bluetooth” procedure following a message sent by the positioning beacon B₁. The connection between the two items of equipment may then be established.

According to one embodiment, once the connection is established and the data is exchanged between the two items of equipment, a period without connection may be configured before the next automatic connection.

Depending on the protocol and the type of link used, the terminal T₁ and the positioning beacon B₁ include an electronic chip making it possible to establish a data link. These links are preferably two way links. However, the invention may use a one way link in embodiments wherein such a link is sufficient to pair the two items of equipment.

Its objective is to pair the two items of equipment T₁, B₁ with each other, notably to exchange identifiers, possibly calibration data such as reference angles and/or clocks before exchanging information later. Other data may be exchanged such as equipment identifiers, network identifiers, application identifiers or users. Further, the following data may notably also be exchanged between the two items of equipment: data specific to the hardware configurations of the equipment, the bit rate of the protocol used to establish the data link, the types of software versions of the equipment, or data related to user or equipment access rights.

The link L₂ is a link established by means of the UWB protocol. This protocol also bears the name of the UWB frequency band that is used to exchange data between the positioning beacon B₁ and the terminal T₁.

According to one embodiment, the link L₂ is two way between the two items of equipment B₁ and T₁. In this case, this link L₂ allows data exchange according to an exchange sequence between the two items of equipment T₁ and B₁ making it possible to transfer parameters of the position of the terminal T₁.

According to another embodiment, the link L₂ is one way between the two items of equipment B₁ and T₁. In this case, this link L₂ allows a data transfer from terminal T₁ to the beacon B₁ in order to receive parameters of the position of the terminal T₁ which will make it possible to reconstruct elements of the position POS₁ with a clock synchronized between the two items of equipment B₁ and T₁.

FIG. 1 also shows data networks NET₁ and NET₂.

According to a first embodiment, the terminal T₁ is connected to a mobile network such as a 5G data network, LTE with 4G or 4G+ or GSM/EDGE, CDMA2000, TD-SCDMA, UMTS, 3G, H or H+.

According to a second embodiment, the terminal T₁ is connected to a Wifi network, for example the local network accessible from a Wifi access point.

In both cases, the terminal T₁ is connected via the mobile network or the Wifi network to a data network such as the internet network so that the terminal T₁ can access data from a remote data server SERV₁. The terminal T₁ includes the communication interfaces adapted to implementing these data links to receive and send data to one or more remote servers.

With regard to the positioning beacon B₁, the same two types of network interfaces may be implemented. The positioning beacon B₁ may for example comprise a Wifi interface to be connected to a Wifi unit itself connected to the Internet network, alternatively it may be connected directly to the Internet network or configured to be connected to a mobile network as previously defined.

In this example, the server SERV₁ comprises for example a library of 2D or 3D digital objects or data relating to media. These digital objects are also referred to as virtual objects OBVᵢ in the following description.

According to the different embodiments, this library is accessible:
from the electronic terminal T₁ via a communication interface, such as a mobile interface or Wifi,
from the positioning beacon B₁ via a communication interface, such as a mobile or Wifi interface, the terminal T₁ then being able to access the digital object library via the link L₁, such as Bluetooth or Wifi.

According to different embodiments, the terminal T₁ or the positioning beacon B₁ may access different remote servers such as the servers SERV₁, SERV₂ represented in FIG. 1. In the example of FIG. 1, the server SERV₁ is a remote server including a database of virtual objects OBVᵢ, the server SERV₂ is a remote server allowing control of access to the services delivered to the positioning beacon B₁. Thus, the positioning beacon B₁ records a set of virtual objects OBVᵢ of which it knows the relative positions with respect to itself. In order to access these virtual objects OBVᵢ, a third party including a second electronic terminal T₂ is likely to locate an object disposed in a previously disposed room. The invention makes it possible to organize the access rights to a previously disposed virtual object. As an example, an individual may anchor a post-it, i.e. a text note on the wall of the living room intended for his wife without the children being able to access it.

When a user having a terminal T₂ has access to the virtual object OBVᵢ previously deposited at a position POS₁ of a room in which there is the positioning beacon B₁, he can view it thanks to the display of his terminal T₂. Access is made via an electronic terminal T₂ by augmented reality display of the virtual object OBVᵢ on the screen of the electronic terminal T₂ by overlaying the image acquired by its optics.

Access to the virtual object OBVᵢ may be achieved via an electronic terminal T₂ by accessing either directly to the positioning beacon B₁ which has user rights access control, or with a remote data server SERV₂ which comprises a user access module.

Access control may be performed by the server SERV₂ from the positioning beacon B₁ following a request from a terminal T₂.

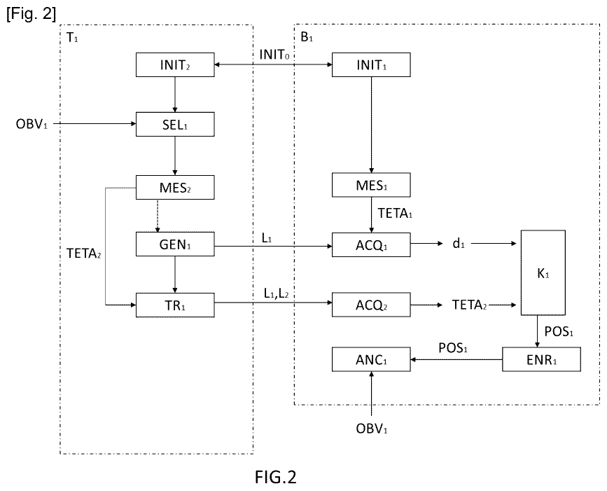

FIG. 2 shows an exemplary embodiment of the method of the invention. A first step relates to the pairing INIT₀ of the apparatuses T₁, B₁ with each other. This pairing INIT₀ may be done once and for all or may be updated from time to time as a function of the potential drifts of certain components of the equipment. FIG. 2 shows the two phases INIT₁ and INIT₂ initiated by each item of equipment during the pairing phase INIT₀.

In this pairing phase, data may be exchanged between the positioning beacon B₁ and the electronic terminal T₁, notably protocol information. According to one example, the positioning beacon B₁ transfers to the electronic terminal T₁ its configuration parameters such as its Bluetooth BLE protocol parameters and its UWB protocol parameters. This could be, for example, the BLE UUID and an UWB identifier. The electronic terminal T₁ in turn sends its own parameters to the positioning beacon B₁.

According to different embodiments, the pairing sequence is initiated by the electronic terminal T₁ or by the positioning beacon B₁.

A re-sending sequence may then be undertaken in order to maintain the connection, this sequence is also called “refresh UWB”, it consists in initiating the pairing procedure from the terminal T₁ in loop until the UWB connection is maintained.

The phase INIT₂ performed by the electronic terminal T₁ comprises reading an orientation indication of a compass system, a compass, a parameter of an inertial unit or an inertial electromechanical microsystem, also called a gyroscope. Navigation systems such as AHRS designating “Altitude and Heading Reference System” or/and INS designating “Inertial Navigation System” both known to those skilled in the art may also be used in the context of the invention.

The orientation indication is commonly a direction with respect to north considered at a given point, it is therefore a straight line passing through a point or a vector of which an origin point and an angle with respect to a Cartesian reference frame is known. Generally, such a component capable of reading an orientation indication with respect to a reference such as magnetic north is noted “orientation device”. The orientation indication TETA₂ is defined with respect to a reference REF₀′ for example with respect to magnetic north. However, any reference other than magnetic north may be used. This may be, for example, the azimuth obtained from a compass system. The orientation indication TETA₂ may be an angle or a direction vector defined in a Galilean reference frame.

The phase INIT₁ performed by the positioning beacon B₁ comprises reading an orientation indication TETA₁ of a compass system, a compass, a parameter of an inertial unit or an inertial electromechanical microsystem, also called a gyroscope. The orientation indication TETA₁ may be an angle or a direction vector defined in a Galilean reference frame. The orientation indication TETA₁ is made with respect to a reference REF₀ for example with respect to magnetic north. However, any reference other than magnetic north may be used. It may also be the azimuth obtained from a compass unit of the beacon B₁. Preferably, the same reference will be used for the positioning beacon B₁ as for the terminal T₁. In this case REF₀=REF₀′.

The interest of having the same reference is to allow calibration of the two items of equipment T₁ and B₁ between them. This calibration step may be performed by placing the electronic terminal T₁ at the position POS₀ of the positioning beacon B₁. The comparison of the deviation between, on the one hand, the orientation indication TETA_{c1} defined by the vector or the line passing through the position of the positioning beacon B₁ and magnetic north N_{M} and, on the other hand, the orientation indication TETA_{c2} defined by the vector or the line passing through the position of the electronic terminal T₁ and magnetic north N_{M} makes it possible to evaluate a deviation EC₁ to be entered in the subsequently performed position measurements of the electronic terminal T₁ calculated using the positioning beacon B₁.

According to one embodiment, the calibrations of the angles of the two items of equipment could be performed at two different positions: POS_{REF2} and POS_{REF1} respectively of the electronic terminal T₁ and the positioning beacon B₁ whose reference angle is known at these respective positions. In this scenario, the position POS_{REF1} may be a position of a remarkable point used to position the positioning beacon at its initialization. This may be a corner of the room or another point.

One interest of defining remarkable points making it possible to position the positioning beacon B₁ in a place is to increase its resilience to a change in position, a shock or a change in its orientation. If the position of the positioning beacon B₁ changes, it can reacquire reference positions using an inertial unit and know its new position.

According to one embodiment, in order to ensure in this calibration phase that the terminal T₁ and the positioning beacon B₁ are indeed in the same position, a 2D or 3D code may be used to ensure the colocation of the two objects at the time of calibration. For example, a QR code or Flash code visible on the positioning beacon B₁ may be read from the optics of the electronic terminal via a software application and decoded so as to send a message, for example Bluetooth, so that the beacon initiates the data exchange with the electronic terminal T₁.

The pairing phase INIT₀ allows the electronic terminal T₁ to be recognized by the positioning beacon B₁. To this end, the terminal T₁ may send an identifier to the positioning beacon B₁ that has been previously recorded in a memory of the beacon or in a remote server such as the server SERV₂. This identifier defines a parameter according to a predefined configuration to access rights. The rights allow, for example, the terminal T₁ thus recognized to either insert virtual objects OBVᵢ in an area covered by the positioning beacon B₁ or to display virtual objects OBVᵢ already disposed in an area of the room covered by the positioning beacon B₁.

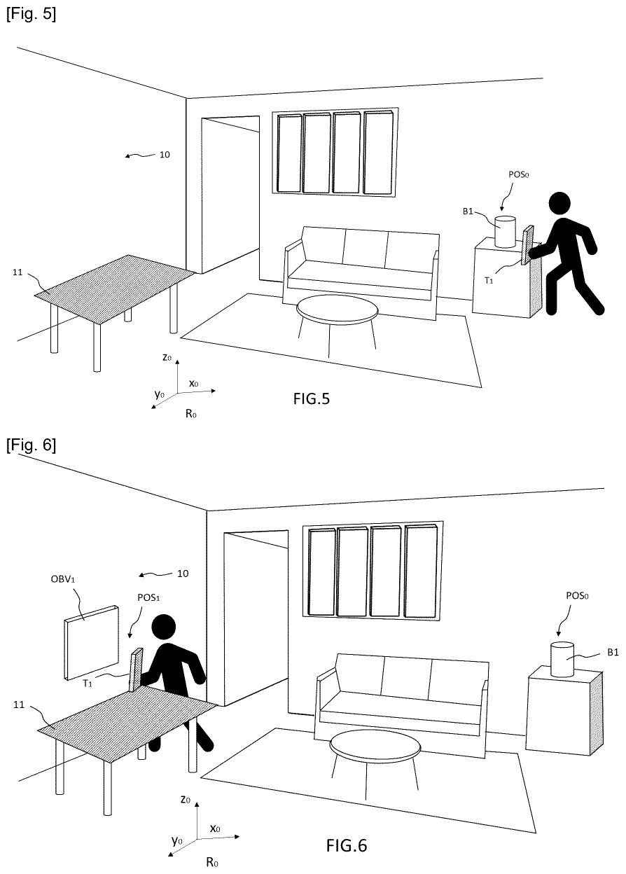

FIG. 5 shows a situation of a room in which a user performs a pairing of his electronic terminal T₁ with the beacon by standing at the same position. This pairing makes it possible to measure the deviation of the reference angles with respect to magnetic north. The deviation makes it possible to adjust a calibration of the two items of equipment when the positioning beacon B₁ will later estimate the position of the electronic terminal T₁.

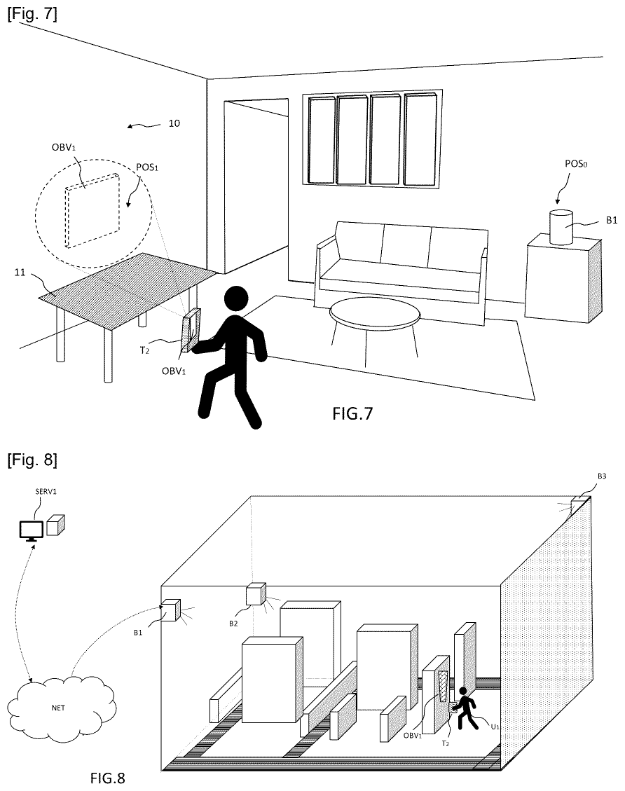

Following this pairing, the user equipped with his terminal will dispose against the wall 10 of the room at a given position a virtual object OBV₁ here materialized by a poster or a picture arranged on the wall at the position of the electronic terminal T₁. The virtual object OBV₁ will then be able to be viewed, as shown in FIG. 7, at this augmented reality position from the terminal T₁ or another terminal T₁ of another user that will be identified with the positioning beacon B₁ and that will be in the room. FIG. 7 shows a user observing the virtual object OBV₁ through the display of his terminal T₂ by pointing the optics of his terminal towards the position of the wall where the virtual object OBV₁ is located.

Without a terminal, the virtual object OBV₁ cannot be viewed, it can only be viewed via an electronic terminal T₁ with access rights.

The method of FIG. 2 includes a step SEL₁ executed on the terminal T₁ aiming at choosing and selecting a virtual object OBV₁ that can be recorded in different memories according to the embodiments of the invention or the use chosen by the user. Indeed, according to one embodiment, the virtual objects may be mostly accessible from a data server via the internet network, but it is understood that the user could in some cases have a library of virtual objects recorded in a memory of its terminal T₁ or access objects recorded in a memory of the positioning beacon B₁.

When a virtual object OBV₁ is selected, a command makes it possible to anchor said virtual object OBV₁ at the current position or near the electronic terminal T₁. To this end, a sequence of steps is performed aiming at transmitting elements of the position of the electronic terminal T₁ to the positioning beacon B₁. Among the sequence of steps, a first action consists in measuring an orientation indication, for example an angle with respect to a reference such as an axis, magnetic north or a direction vector oriented in a reference frame, and sending it to the positioning beacon B₁ and a second action aims to send at least one UWB message so that the positioning beacon B₁ can determine the distance at which the electronic terminal T₁ is located.

The method of the invention therefore comprises performing a first action comprising a measurement MES₂ of the orientation indication TETA₂ at the time t when the user activates an anchoring command. The orientation indication is preferably an angle with respect to a reference such as the direction of a compass. The anchoring command may be done by a specific action or by selecting and validating a chosen virtual object OBV₁. The measurement of the orientation indicator corresponds as detailed previously to an angle measurement with a reference. It may therefore be the oriented direction vector between the current position of the electronic terminal and magnetic north. This oriented direction vector defines an angle. This angle is advantageously transmitted to the positioning beacon B₁. The measurement may be transmitted via the link protocol L₁ such as Bluetooth or Wifi or via the link L₂ in UWB.

The second action comprises the sending of an UWB message from the electronic terminal T₁ to the positioning beacon B₁. In order to determine the distance between the electronic terminal and the positioning beacon, two solutions are possible.

The first relies on the fact that the positioning beacon B₁ and the electronic terminal are synchronized and share a common clock with an accuracy of, for example, nanosecond accuracy. The synchronization may be done during pairing or in a separate sequence. The synchronization may be regularly reset between the two items of equipment. Finally, the synchronization may be carried out alternatively or in combination with a third-party service.

In this first solution, the UWB message is sent by the electronic terminal T₁ with a data encoding the send date of said message. When the message is received, the positioning beacon B₁ timestamps the date of arrival of the message and the time of flight may be calculated between the two items of equipment. From the time of flight, the distance between the two items of equipment is easily calculated.

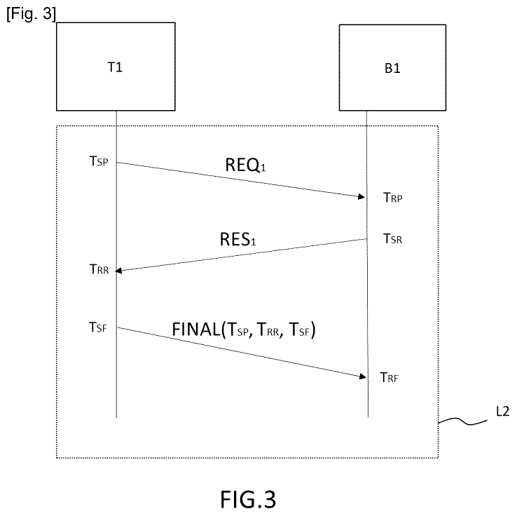

FIG. 3 illustrates a second solution that does not impose a prior synchronization sequence between the two items of equipment, however this solution imposes a UWB two way exchange of data between the two items of equipment. This sequence is better known in the literature as “Two Way Ranging”, with the acronym TWR.

The electronic terminal T₁ sends a “Poll” message to the known address of the positioning beacon B₁. This is called the sending time T_{SP} of the request REQ₁. The positioning beacon B₁ then records the reception time TRP of the request REQ₁ and responds with the reply message RES₁ at the time of sending the reply T_{SR}.

The electronic terminal T₁, upon reception of the reply message RES₁, then records the time of reception of the reply T_{RR} and composes the final message FINAL (T_{SP}, T_{RR}, T_{SF}), in which its ID, its T_{SP}, its T_{RR} and its final start time T_{SF} are included.

Based on the time of reception of this final message FINAL(T_{SP}, T_{RR}, T_{SF}), the positioning beacon B₁ can then determine the time of flight of the UWB signal. One advantage of this method is that no time synchronization is required between the UWB apparatuses.

According to one embodiment, the UWB message exchange sequence comprises information specific to the protocol, connection times, communication times, equipment identifiers, etc.

Optionally, the resulting distance may be returned in the report message to the electronic terminal or any given UWB apparatus in the neighborhood. One interest is to calculate a position of the terminal more precisely in the case of a system including several positioning beacons. Experience shows that the maximum distances that can be calculated between the electronic terminal T₁ and the positioning beacon B₁ to engage the TWR process can range up to several dozens of meters, such as 50 m, an optimal operating distance is between 1 meter and 30 meters, allowing use cases suitable for home or office or showrooms for example.

According to one embodiment, the UWB message transmission sequence is repeated a plurality of times so as to obtain a more precise distance and therefore a more precise position of the virtual object OBVᵢ with respect to the positioning beacon B₁. The position may be obtained by averaging the positions generated according to different UWB message transmission sequences.

According to one embodiment, the orientation indication TETA₂ is sent in an UWB message. For this purpose, this data is encoded to be sent according to an UWB modulation. One interest is to transmit the angle data at the same time as the message that will be used to calculate the distance. This embodiment is represented in FIG. 2 by a dashed arrow between step MES₂ and step GEN₁.

According to another embodiment, the orientation indication TETA₂ is sent according to another data protocol, such as the Bluetooth transmission protocol. FIG. 2 shows the step of transmission TR₁ of the angle data TETA₂ to the positioning beacon B₁ which acquires this data at step ACQ₂.

FIG. 2 shows a case in which the step of generating the UWB message is noted GEN₁ and the step of transmitting the orientation indication is noted TR₁. FIG. 2 shows an arrow indicating the two possible types of links L₁ or L₂, i.e. according to a Bluetooth link for example and according to an UWB link. In this case, it is understood that the generation of the send command GEN₁ of the message can automatically drive the transmission step TR₁ of the orientation indication TETA₂.

The orientation indication TETA₂ may be calculated following the generation step GEN₁ or read in a memory if the value was previously calculated at the time of generation GEN₁.

According to one embodiment, the virtual object selected by means of the electronic terminal T₁ includes an identifier and a locator on a resource of the network, for example a HyperText link, an url or an address of a machine accessible from the network. The data used to identify the virtual object and to retrieve all the data making it possible to display it on a display may be sent to the link L₁ between the electronic terminal T₁ and the positioning beacon B₁.

According to another example not shown in FIG. 2, the virtual object OBV₁ is selected from the electronic terminal that is connected to the positioning beacon B₁ via the link L₁ and the data of the virtual object OBV₁ is retrieved directly from the positioning beacon from a remote server or a memory of said terminal.

FIG. 2 also shows the steps of the method of the invention carried out at the positioning beacon B₁. During the pairing phase INIT₁, an orientation indication TETA₁ is measured during step MES₁. According to one embodiment, this measurement, in addition to being performed during pairing, is performed at regular times.

According to one embodiment, an action of the user on his terminal makes it possible to send a command, for example via a link L₁ to cause a new measurement of the orientation indication TETA₁ of the positioning beacon B₁, typically in the case where he would move the positioning beacon B₁.

According to one example, the positioning beacon B₁ includes a motion detector in order to detect a movement of the positioning beacon B₁ and automatically activate a new measurement of orientation indication TETA₁. This motion sensor may be of the optical type with a measurement of light information, mechanical for example with the use of a position lug or with an accelerometer.

The value of TETA₁ is used during the acquisition by the positioning beacon B₁ of an UWB message sent by the electronic terminal T₁ to deduce the position of the terminal T₁.

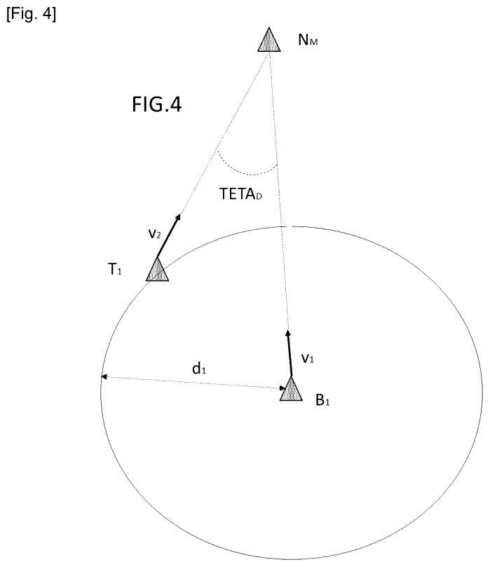

Indeed, the position of the positioning beacon will be deduced from the distance separating the positioning beacon B₁ from the terminal T₁ by means of the time of flight measurement and the orientation of the terminal with respect to the positioning beacon B₁ will be deduced from a calculation taking into account the orientation indication measured by the electronic terminal T₁ and the orientation indication measured by the beacon. This calculation may correspond to an angle difference. FIG. 4 illustrates an example of calculation from geometric considerations of the parameters of the position of the electronic terminal T₁. The orientation indication is represented by a vector oriented towards magnetic north N_{M}. It is understood in this figure that the difference in angle TETA_{D} of the two vectors makes it possible to give an indication of the orientation of the electronic terminal T₁ with respect to the position of the positioning beacon B₁. A simple approximation consists in considering the triangle as an isosceles given the ratio of the triangle lengths, magnetic north N_{M} being theoretically a point much further away than the distance between the electronic terminal T₁ and the positioning beacon B₁.

Another way of doing this is to estimate that there is only one point on the circle represented satisfying the conditions of distances di and angle TETA₂ given by the vector V₂ in a Galilean reference frame.

The positioning beacon B₁ comprises a calculator K₁ making it possible to perform the calculations resulting in the estimation of the position of the electronic terminal T₁ noted POS₁. This position is then recorded in a memory of the positioning beacon B₁. This step is noted ENR₁ in FIG. 2.

The position POS₁ will then be associated with the selected virtual object OBV₁. The method of the invention makes it possible to create a data pair (ID_{OBV1}, POS₁) of which one data is an identifier of the object ID_{OBV1} and the other data is its position POS₁ that is associated with it.

According to one example, a predefined height is automatically associated with this object. This feature makes it possible to have all the information to anchor a virtual object OBVᵢ in space. For example, a height of 1 m20 may be predefined and associated with all the virtual objects. According to another example, the default height is set at 0 with respect to the ground level. According to another example, the height is defined at half the height of the ceiling. This height may be configured by a user and customized according to the height of the user or a data that the user wishes to specify during the initial configuration.

According to another example, the height of the person recorded in the configuration phase makes it possible to deduce the average height of the telephone in its average use. This height may be used by default.

According to one embodiment, the height is a variable data dependent on the selected class of virtual objects. For example, if virtual objects are classified into 3 classes: furniture, display, other, it is possible to associate 3 predefined heights respectively: {0; 1 m60; 1 m20}.

One advantage is to allow a default average positioning of the height of the object in the room. A software function may allow this height to be changed once the virtual object OBVᵢ is anchored in the room.

The positioning beacon comprises a memory in which all the associations of the virtual objects OBVᵢ of which it has associated positions are recorded.

### Use of Predefined Positions

According to one embodiment, a user may record in a memory of the positioning beacon B₁ several predetermined positions of the room in which the positioning beacon B₁ is located. These positions may result, for example, from previous anchorings made.

One advantage is to allow a subsequent new anchoring at an already known position that does not require a new movement of the user with his electronic terminal to the position at which he wishes to perform a new anchoring. This embodiment allows, for example, an individual to associate with a virtual object OBVᵢ remotely. This association is achieved by access to its positioning beacon B₁ thanks to access and user rights control which can be achieved by means of a remote server such as SERV₂. Assuming that he has the rights to the positioning beacon B₁, for example if the positioning beacon B₁ is disposed at his home, this user could select a predefined position of the already recorded room to associate a new virtual object OBVᵢ selected from his terminal T₁. According to an exemplary embodiment, a 3D or 2D representation of space makes it possible to view the position in the room with respect to a reference point corresponding to the positioning beacon.

This representation of the room may, for example, be performed beforehand during a parameterization phase. By way of example, a user could move in the room covered by the positioning beacon with his electronic terminal T₁ to anchor the 4 corners of the room so that the positioning beacon B₁ records the dimensions of the room. A software function would then make it possible to define a corresponding volume representing the room and several reference points in order to position therein already defined positions. One advantage is, for example, to leave a virtual object such as a message when an individual travels for a family member at home.

### Adjustment of the Position

According to one embodiment of the method of the invention, a user anchoring a new virtual object OBVᵢ at a given position of a room may adjust the position of said virtual object OBVᵢ and its orientation in space.

This software function makes it possible, for example, to initially display the object in a 3-dimensional space. The user can move the virtual object OBVᵢ in the room from a touch display of the terminal T₁. The height may thus be adjusted as well as the other position parameters of the virtual object OBVᵢ. The new position may thus be re-sent via the link L₁ to the positioning beacon to update the position POS₁ associated with the virtual object OBVᵢ.

According to one embodiment, the orientation of the virtual object OBVᵢ in space may be modified by the user. Similarly, this change of orientation may be carried out from a touch command on the display of the electronic terminal T₁ then be sent to the positioning beacon B₁. According to a first example, the orientation of the virtual object OBVᵢ may be adjusted to the nearest degree by a movement of the virtual object OBVᵢ on the display of the electronic terminal T₁. According to an alternative, the orientation may be modified according to predefined transformations, for example 90° rotations according to the 3 rotation angles defined in a Cartesian reference frame.

According to one example, when the 4 corners of the room are defined, the positioning beacon is able to generate a horizon line of the room defined by a segment between two adjacent corners. This possibility makes it possible to define a default orientation of the virtual object in space. Indeed, it may be oriented with respect to this horizon line.

Finally, according to one embodiment, the user modifying the orientation and the final position of the virtual object that has just been anchored in a first step can access via the display of his terminal representing an image acquired from his optics the context or the environment close to the virtual object that has just been anchored. Thus, the display will represent the virtual object OBI in its real environment in which it has been anchored, i.e. the presence of a wall, table or lamp or any other object already present in the room. According to one embodiment, the user has the possibility of selecting pixels of the image. A software function may be implemented to identify and generate a surface belonging to a real object of the scene such as a surface of a table or that of a wall. One option of this software function is to make it possible to activate a magnetic function aimed at matching a coordinate of the end of a dimension of the virtual object OBVᵢ with a coordinate of a surface of the determined real object and then assigning this coordinate of the real object to a coordinate of the virtual object. The placement of a virtual object may be achieved by means of a shape detection software function. The acquisition of the image by the optics of the electronic terminal makes it possible to generate an input of a shape and contour detection algorithm so as to segment the real objects in the scene. The software function aiming to move the virtual object in contact with a detected surface of a shape is carried out by matching a coordinate of the position of the object with a surface of an edge of a detected geometric surface.

In other words, this software function makes it possible to match the height of the table to the height of the object, for example by considering its smallest dimension. One interest of such a function is to position the virtual object in a real context while respecting the spaces already occupied by the real objects in the room.

According to an exemplary embodiment, a second user viewing a virtual object OBV₁ anchored by a first user in the space may have the rights to modify for example its orientation and not its position.

According to one embodiment, the user having anchored a virtual object or a user having access to a virtual object already anchored to view it may, from his user interface, zoom in on the object, move it, change its orientation, or change its appearance for example by modifying the colors or the texture of at least one surface of the element.

According to one embodiment, a user U₂ having a terminal T₂ and viewing a virtual object OBV₁ already anchored by another user U₁ and therefore by means of another terminal T₁, may activate a command with a view to notify the user U₁ having anchored it of the correct reading of the virtual object OBV₁. This command may also be generated automatically once the virtual object OBV₁ is viewed by the second terminal T₂. For this purpose, the terminal T₂ viewing the virtual object anchored to a position POS₁ may send a message for example via the link L₁ or L₂ to notify the positioning beacon B₁ that the virtual object OBV₁ has been consulted by the user U₂. When the positioning beacon B₁ is connected to the internet network either directly or via a Wifi terminal, a message may be sent over the internet network or via a mobile network to notify the first terminal T₁ of the consultation of the object OBV₁ by the user U₂.

### Different Types of Virtual Objects

According to one embodiment, the virtual objects are 3-dimensional statistical objects. According to another example, a virtual object OBVᵢ may comprise an animation such as a safe that opens. According to another example, a virtual object may be an avatar of an individual or an avatar of a character that can be animated for a period of time. For example, it is possible to anchor an avatar of a character delivering an audio message. According to another example, the virtual object is a thumbnail allowing a multimedia file to be read. According to another example, the virtual object is a note for example for displaying the shopping list.

### Case of the Multi-Positioning Beacon

FIG. 8 illustrates an embodiment in which several positioning beacons are used to obtain a position of the terminal. The position may be obtained:
either by a combination, on the one hand, of the orientation indications and, on the other hand, of the estimates of the distances between the electronic terminal T₁ and each positioning beacon B₁, notably thanks to a method for estimating the differences in the arrival times of the UWB messages received by the positioning beacons {Bᵢ}ᵢ;
or by a calculation of the position of the terminal made only from the estimates of the differences in arrival time of the UWB messages received by the positioning beacons {Bᵢ}ᵢ.

FIG. 8 shows an example of a museum in which an electronic terminal T₂ is located by three positioning beacons B₁, B₂, B₃. A user U₁ equipped with his terminal T₂ seeks to place a virtual object OBV₁ such as a numerical table at a given position.

The position may be obtained by a trilateration calculation of the differences in the arrival time of UWB messages sent by the electronic terminal T₂ and by the calculation of the orientation indication of the terminal at the position at which the user U₁ wishes to anchor the virtual object.

In this scenario, the three tags B₁, B₂, B₃ make it possible to obtain 2 distances. In this case, the orientation indication is necessary to reconstruct a complete position. If an additional fourth positioning beacon B₄ is used then it is possible to reconstruct a complete position from the calculation of 3 distances between 3 positioning beacons and the electronic terminal T₁ without requiring an orientation indication.

This scenario makes it possible to avoid the transfer of angles between the two items of equipment, however this measure makes it possible to consolidate the estimation of the position.

### Master Terminal

According to one embodiment, when a positioning beacon B₁ is installed, a terminal T₁ is determined as being the master terminal T_{M} having administrator rights to assign rights to other terminals with respect to the virtual objects that may be selectable or viewable. One interest is to allow the rights of virtual object libraries to be administered, for example to allow children to use some object libraries and to limit access to other libraries.

### Access to Virtual Objects

According to one example, when a user Uᵢ provided with his terminal T₁ anchors a virtual object OBVᵢ at a given position, the method comprises a step aimed at assigning user rights to other terminals referenced with the positioning beacon B₁. One interest is to deliver messages dedicated to a subset of terminals or to a given terminal.

Thus, a plurality of users having each associated their terminal with the positioning beacon B₁ will not all view a virtual object OBVᵢ on the display of their terminal. The display will be activated or not as a function of the rights they have been given respectively.

According to one embodiment, the association of a new electronic terminal with the positioning beacon is subject to a validation of the master terminal T_{M}. To this end, during a sequence of a new pairing of an electronic terminal, the positioning beacon B₁ sends a message via a Bluetooth or Wifi link L₁ to the master terminal. This message may also be sent via the server SERV₂ after the positioning beacon B₁ has sent a notification of adding a new electronic terminal to the server SERV₂. In this case, the server SERV₂ is configured to automatically send an authorization request message of a new electronic terminal within a memory of the positioning beacon B₁. If a validation is performed at the master terminal then the new terminal is added to the list of equipment able to add a new virtual object with the positioning beacon Bᵢ and/or view virtual objects anchored by the positioning beacon B₁.

### Meshing of Positioning Beacons

According to one embodiment, when a positioning beacon is connected to a Wifi terminal such as an access beacon to the internet network. The invention makes it possible to mesh the different positioning beacons within a data network so as to administer and geolocate them from a web application, for example.

One interest is to offer an administration of a plurality of positioning beacons in a place including different positioning beacons such as a museum.

### Example of a Beacon

According to one embodiment, a positioning beacon comprises a calculator such as a microcontroller, a memory, a compass system or a compass or an inertial unit, and a set of communication interfaces comprising notably an UWB interface and a Bluetooth interface. According to an improved embodiment, the positioning beacon comprises a Wifi interface. According to an improved embodiment, the beacon comprises a secure element. This secure element is materialized by an electronic chip separate from the microcontroller. Its objective is to secure transactions, i.e. data exchanges via the different data protocols implemented between the different items of equipment.

According to a first example, the system of the invention may be used to display information in a store from a screen available in the store or from his smartphone. The virtual object may in this case be information with respect to an article or a virtual representation of a real object in another configuration for example according to another size or another color. In this use case, the system may comprise a plurality of tags in the store. Access rights to the objects may be activated on any terminal that has paired with a pairing beacon at the store entrance. Thus, in this embodiment, the positioning beacon may be different from a pairing beacon making it possible to give access to a catalog of virtual objects. According to one embodiment, the pairing beacon may be connected to an access rights management server making it possible, for example, to perform an authentication check. One interest may be, for example, to propose additional services to subscribers such as price discounts or to present an additional catalog, for example of a limited-edition object. According to one embodiment, a user may associate his terminal identifier with a customer account of the store, which makes it possible to give the resources necessary for the authentication check to activate or not service. Thus, in this mode of use, the system of the invention comprises at least one specific pairing beacon at the entrance to the location and an authentication check.

According to a second example, the system of the invention may be used in exhibition rooms or museums to deliver information in the vicinity of a work. One interest is to allow a user to access information directly at a position close to the work that he is consulting or discovers. One interest of this solution is to offer rich multimedia content. For example, equipped with a touch display, a user may read a text constituting all or part of the virtual object next to a picture that constitutes a real object. Then, once the text has been read, the user can “zap” or change the content with a finger movement on his display to obtain images, or even sound, a video or another text or the remainder of the first text. Thus, a user can easily access rich content that may be updated at any time by a virtual content administrator. It is understood in this example that the virtual object may be a sequence of multimedia contents ordered or linked to each other. According to one example, the content chain may comprise a text TEXT₁, a video VIDEO₁, a text TEXT₂, an image IMAGE₁, another video VIDEO₂. Thus, the virtual object is a chain thus constituted of virtual elements defining a virtual object: {TEXT₂, VIDEO₁, TEXT₂, IMAGE₁, VIDEO₁}. In this example, the system of the invention comprises a memory for storing chained virtual objects, access to one or more multimedia libraries, and a display of a terminal making it possible to browse between the different elements of a virtual object.

According to a third example, the virtual object is an animated 3D object, it may also be a hologram visible from a display of an electronic terminal. One interest of such an application is to anchor at a given position an intervention of a first individual represented by his hologram and visible from a display of an electronic terminal of another individual wishing to view the first individual. The first individual may for example be located at a position in another location and his image may be acquired by means of an optic such as a 3D camera. The 3D image may be processed in such a way that it is separated from the rest of the image from an image processing algorithm allowing the 3D video of the first individual to be outlined. A set of data describing the 3D video and preferably the sound track if it is present may then be transmitted via a data network to a library of virtual objects stored on a memory of a remote server. The virtual object may then be downloaded when anchoring to the positioning beacon. According to a first alternative, the entire video is downloaded to the positioning beacon in order to be subsequently generated at a given position when a second individual views the image of the hologram on his electronic terminal. According to one embodiment, a real-time continuous streaming mode makes it possible to generate the video in real-time from a remote server. According to this application, the start of the video may be actuated by a user command from his terminal which is sent to the positioning beacon. In this case, the positioning beacon can generate the video start on a user command at the desired position.

According to an exemplary embodiment, the terminal comprises an UWB electronic chip including 3 UWB receivers oriented within the terminal along different axes in order to detect the arrival angles of the UWB messages sent by the tag. This solution notably makes it possible to improve the calculations of the orientation of the terminal with respect to the beacon sending the UWB message. One interest is to strengthen the measurement of angles, notably of the beacon with respect to magnetic north and the terminal with respect to the magnetic north, by adding reliability information of the arrival angle of the UWB signal sent by the beacon to the terminal. This solution may be used robustly with a single beacon and an electronic terminal even with an angle measurement in relation to magnetic north which can be sensitive depending on the apparatuses and the mobility of the terminal when held by a user.

1. A method for anchoring a virtual object to be displayed on an electronic display of an electronic terminal at a given position in space, said method comprising:
initializing a wireless communication between an electronic terminal and at least one positioning beacon to record an identifier of said electronic terminal in a memory of said positioning beacon;
selecting a virtual object from the electronic terminal and identifying said virtual object by said positioning beacon;
measuring a first orientation of the positioning beacon with respect to a reference from a first orientation device;
measuring a second orientation of the electronic terminal with respect to a reference from a second orientation device;
generating a command to send a first signal generated by an UWB communication interface of the electronic terminal;
acquiring by the positioning beacon of a first signal sent by means of an UWB communication interface of the electronic terminal;
measuring a transmission parameter of the first signal by the positioning beacon;
transmitting a second data encoding the second orientation by the electronic terminal;
acquiring by the positioning beacon of the second orientation sent by the electronic terminal;
calculating a first position from the second orientation and from the transmission parameter of said electronic terminal;
recording the first position defined with respect to the terminal;
anchoring a position of the virtual object at the first position, said anchoring including an association of said virtual object with the first position.

2. The method for anchoring according to claim 1, wherein said method is implemented by a single beacon and said electronic terminal.

3. The method for anchoring according to claim 1, wherein the second data encoding the second orientation by the electronic terminal is transmitted:
by means of the sending of a second signal sent by a Bluetooth communication interface or;
by means of an encoding of the second data within the first signal sent by the UWB interface or;
by means of the sending of a third signal sent by a WIFI communication interface.

4. The method for anchoring according to claim 1, wherein the measurement of the orientation of the electronic terminal and/or the positioning beacon carried out by the orientation device is performed by means of a compass system, a compass, a gyrometer or an inertial unit.

5. The method for anchoring according to claim 1, wherein the first virtual object is selected from:
a memory of the electronic terminal;
a memory of the positioning beacon and accessible from the electronic terminal by the activation of a data exchange implemented by a WIFI or Bluetooth link;
a memory of a remote server and accessible from the electronic terminal by the activation of a data exchange implemented by a WIFI or Bluetooth link.

6. The method for anchoring according to claim 1, wherein the first UWB signal sent by the electronic terminal is a message of a two way UWB data exchange sequence, so-called Two way UWB ranging, wherein a measurement of the time of flight makes it possible to calculate a distance between the electronic terminal and the positioning beacon.

7. The method for anchoring according to claim 1, wherein the first UWB signal sent by the electronic terminal is a message of a one way UWB data transmission sequence wherein a measurement of the time of arrival of the first signal makes it possible to calculate a distance between the electronic terminal and the positioning beacon, a calculation of the first distance being calculated from a prior synchronization of clocks of the first electronic terminal and the positioning beacon.

8. The method for anchoring according to claim 1, wherein the first UWB signal sent by the electronic terminal is a message of an UWB data transmission sequence wherein a plurality of positioning beacons allows a measurement of the distance of the arrival time differences of the first signal between pairs of positioning beacons makes it possible to calculate a distance of the electronic terminal with respect to the positioning beacon.

9. The method for anchoring according to claim 1, wherein the initializing comprises a calibration of the first and second orientation devices, the calibration comprising a measurement of an orientation indication of the positioning beacon and a measurement of an orientation indication of the electronic terminal, said measurements being carried out at the same reference position of each equipment.

10. The method for anchoring according to claim 1, wherein the initializing comprises an initialization sequence of the positioning beacon, said initialization sequence comprising:
reception by the positioning beacon of a reference orientation of the electronic terminal for a given position of the electronic terminal;
reception by the positioning beacon of a reference height;
reception by the beacon of a user identifier and/or an identifier of the electronic terminal.

11. The method for anchoring according to claim 1, wherein the virtual object is defined by a plurality of points and surfaces delimiting a region associated with a Cartesian reference frame and comprising a 3D representation that can be generated on a display of an electronic terminal according to a viewing angle.

12. The method for anchoring according to claim 1, wherein the calculating of the first position comprises:
assigning at least one first reference coordinate corresponding to the height of the virtual object defined from a predefined configuration at a coordinate of the first position.

13. The method for anchoring according to claim 1, wherein the calculating of the first position comprises:
an acquisition of an image of an area of the space in which the virtual object is represented in 3D and is positioned at the first position on a display of the first electronic terminal;
a calculation of a second reference coordinate of at least one reference point associated with an automatically detected element from an algorithm for processing the acquired image in which the virtual object is represented;
assigning the second reference coordinate to a coordinate of the first position.

14. A method for displaying a virtual object having been anchored according to the method of claim 1, comprising:
sending an identification request from a second electronic terminal to the positioning beacon, said identification request including an identifier recorded in a memory of the second electronic terminal;
generating a reply including a virtual object identifier and said anchoring position of said virtual object with respect to the positioning beacon;
displaying said virtual object on a display of the second electronic terminal overlaying an image acquired by an optic of said second electronic terminal.

15. A computer program product comprising at least a calculator and a memory and comprising instructions which, when the instructions are executed by a computer, cause the instructions to implement the steps performed by the electronic terminal of the method according to claim 1.

16. A computer program product comprising at least a calculator and a memory and comprising instructions which, when the instructions are executed by a computer, cause the instructions to implement the steps performed by the positioning beacon of the method according to claim 1.

17. A system for anchoring a virtual object, said system comprising:
a positioning beacon including a memory and a calculator and a first UWB communication interface;
an electronic terminal including a second UWB communication interface;
the positioning beacon and the electronic terminal being configured to implement the method of claim 1.
